(19) United States
(12) Patent Application Publication
(10) Pub. No.: US 2024/0256673 A1
(43) Pub. Date: Aug. 1, 2024

(54) MULTI-PARTY AUTHORIZED SECURE BOOT SYSTEM AND METHOD

(71) Applicant: Dell Products, L.P., Round Rock, TX (US)

(72) Inventors: Mukund P. Khatri, Austin, TX (US); Eugene David Cho, Austin, TX (US)

(73) Assignee: Dell Products, L.P., Round Rock, TX (US)

(21) Appl. No.: 18/160,432

(22) Filed: Jan. 27, 2023

(51) Int. Cl. G06F 21/57; G06F 9/4401; H04L 9/08

(52) U.S. Cl. CPC G06F 21/575; G06F 9/441; H04L 9/0844

(57) ABSTRACT

Embodiments of systems and methods to provide multi-party authorized secure boot authentication are disclosed. In an illustrative, non-limiting embodiment, a processing device may include computer-executable instructions to, during a boot process of the processing device, identify two or more secure boot keys that may be used to authorize, using an authentication process, an ensuing phase of the boot process, identify a subset of the secure boot keys that are to be used to perform the authentication process, and using each of the subset of secure boot keys, perform the authentication process.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Modern day IHS administrative management is often provided via Baseboard Management Controllers (BMCs) also referred to as Remote Access Controllers (RACs). The BMC generally includes a specialized microcontroller embedded in the IHS, and may provide an interface between system-management software and platform hardware. Different types of sensors built into the IHS report to the BMC on parameters such as temperature, cooling fan speeds, power status, operating system (O/S) status, and the like. The BMC monitors the sensors and can send alerts to a system administrator via the network if any of the parameters do not stay within pre-set limits, indicating a potential failure of the system. The administrator can also remotely communicate with the BMC to take certain corrective actions, such as resetting or power cycling the system to get a hung O/S running again. These abilities can often save on the total cost of ownership of an IHS, particularly when implemented in large clusters, such as server farms.

### SUMMARY

Embodiments of systems and methods to provide multi-party authorized secure boot authentication are disclosed. In an illustrative, non-limiting embodiment, a processing device may include computer-executable instructions to, during a boot process of the processing device, identify two or more secure boot keys that may be used to authorize, using an authentication process, an ensuing phase of the boot process, identify a subset of the secure boot keys that are to be used to perform the authentication process, and using each of the subset of secure boot keys, perform the authentication process.

According to another embodiment, a multi-party authorized secure boot method includes the steps of identifying two or more secure boot keys that may be used to authorize an ensuing phase of the boot process during a boot process of a processing device, identifying a subset of the secure boot keys that are to be used to perform the authentication process, and using each of the subset of secure boot keys, performing the authentication process.

According to yet another embodiment, a memory storage device with program instructions stored thereon may be executed by a processing device to identify two or more secure boot keys that may be used to authorize, using an authentication process, an ensuing phase of the boot process during a boot process of the processing device. The program instructions may then identify a subset of the secure boot keys that are to be used to perform the authentication process, and using each of the subset of secure boot keys, perform the authentication process.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIGS. 1A and 1B are block diagrams illustrating certain components of a chassis comprising one or more compute sleds and one or more storage sleds that may be configured to implement the systems and methods described according to one embodiment of the present disclosure.

FIG. 2 illustrates an example of an IHS configured to implement systems and methods described herein according to one embodiment of the present disclosure.

FIG. 3 illustrates an example boot process that may be performed by the multi-party authorized secure boot system according to one embodiment of the present disclosure.

FIG. 4 illustrates an example multi-party authorization table (MPAT) that may be used to select which combination of certificates are used to authorize the next ensuing phase of a boot process according to one embodiment of the present disclosure.

FIGS. 5A-5C illustrate how various combinations of certificate keys may be applied using the MPAT of FIG. 4 according to one embodiment of the present disclosure.

FIG. 6 illustrates an example multi-party secure boot authentication method that may be used to provide authentication of the firmware of an ensuing phase of a boot process according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, science, control, or other purposes. For example, an IHS may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price.

The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, touchscreen and/or a video display. The IHS may also include one or more buses operable to transmit communications between the various hardware components.

Certain IHSs may be configured with BMCs that are used to monitor, and in some cases manage computer hardware components of their respective IHSs. A BMC is normally programmed using a firmware stack that configures the BMC for performing out-of-band (e.g., external to a computer's operating system or BIOS) hardware management tasks. The BMC firmware can support industry-standard specifications, such as the Intelligent Platform Management Interface (IPMI) and Systems Management Architecture of Server Hardware (SMASH) for computer system administration.

The BMC firmware is normally proprietary and is often developed by the vendor and shipped along with the BMC to the end user. Nevertheless, industry trends have migrated toward custom BMC firmware stacks (e.g., operating systems) that allow the end user greater control over how the BMC operates. OpenBMC is one example standard under which custom BMC firmware stacks may be generated. In general, openBMC is a collaborative open-source Linux distribution for BMCs meant to work across heterogeneous systems that include enterprise, high-performance computing (HPC), telecommunications, and cloud-scale data centers. As such, BMCs may be configured to support multiple firmware types (e.g., server manufacturer's firmware, open-source firmware like OpenBMC etc.) based on product offerings or customer requirements.

Protecting IHSs from malicious code and malicious actors has become increasingly important such that vendors of the IHSs often equip such IHSs with security features to minimize or eliminate the risk of malicious attacks. For example, IHSs equipped with a Unified Extensible Firmware Interface (UEFI) may verify that IHS firmware is digitally signed, thus reducing the risk of malicious firmware rootkits. Furthermore, Secure Boot-enabled UEFI systems may verify a boot loader signature to determine whether the boot loader is signed with a trusted certificate. Thus, if a rootkit or other item of malware replaces or tampers with the boot loader, the UEFI may prevent the boot loader from executing, thus preventing such malicious code from hijacking a boot process while concealing itself from an operating system. Secure Boot is a type of security mechanism that involves multiple certificates stored in firmware. These certificates may be used to authenticate the integrity of firmware and operating system bootloader images.

Secure Boot may support multiple code signers (e.g., parties), each in different phases (e.g., layers) of a boot process, but generally does not support multiple parties authorizing/signing/verifying the same phase. Having multiple parties introduces complexity, as a subset of parties may only be authorized under specific conditions. Conventional secure boot systems have not heretofore possessed any means to programmatically define the relationship among the code signing parties, particularly when the relationships may evolve over time (e.g., lifecycle management of inter-party relationship). Conventional secure boot systems have not considered that contributing parties can change over time, be revoked, or added (e.g., lifecycle management of party member). For example, the relationship between a customer and vendor of an IHS may change once a warranty expires, or when the IHS is purchased by a third party. As will be described in detail herein below, embodiments of the present disclosure provide a system and method to programmatically provide a secure boot authorization by multiple parties in which the rights to the boot system may be updated in an as-needed manner over the lifecycle of the IHS.

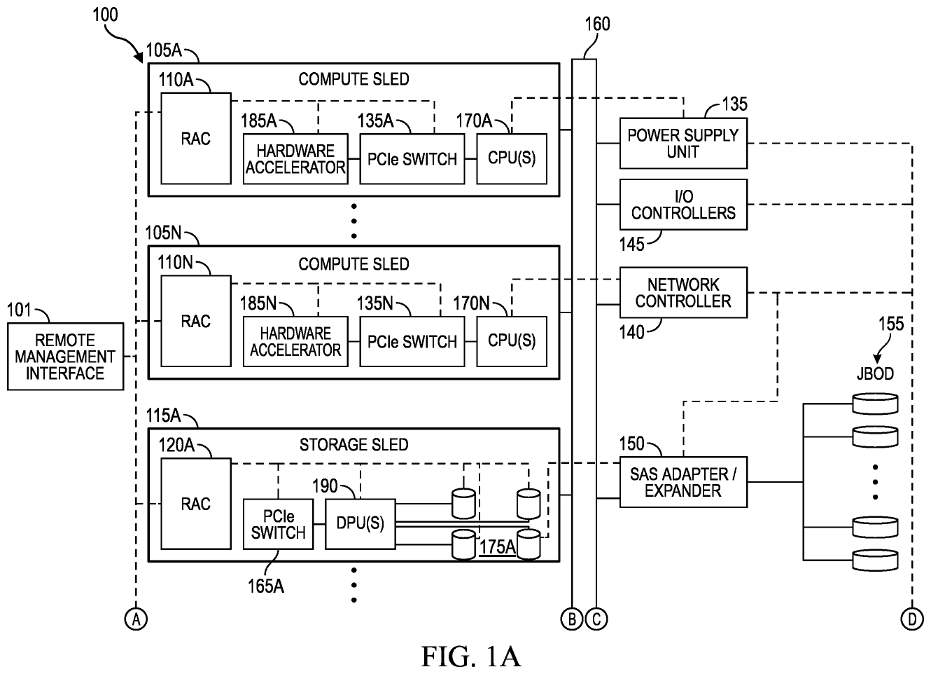

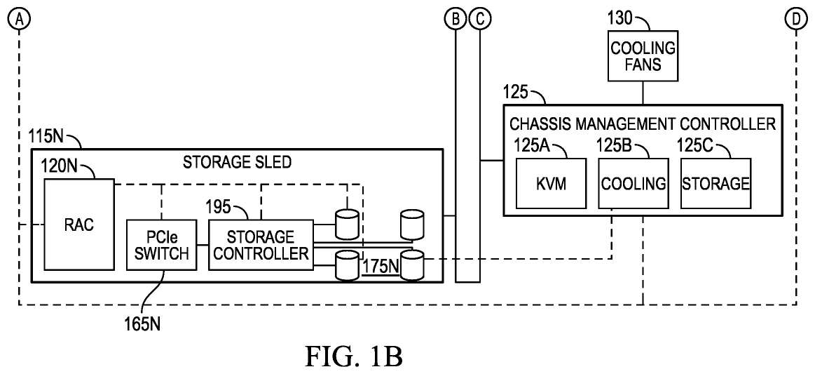

FIGS. 1A and 1B are block diagrams illustrating certain components of a chassis 100 comprising one or more compute sleds 105a-n and one or more storage sleds 115a-n that may be configured to implement the systems and methods described according to one embodiment of the present disclosure. Embodiments of chassis 100 may include a wide variety of hardware configurations in which one or more sleds 105a-n, 115a-n are installed in chassis 100. Such variations in hardware configuration may result from chassis 100 being factory assembled to include components specified by a customer that has contracted for manufacture and delivery of chassis 100. Upon delivery and deployment of a chassis 100, the chassis 100 may be modified by replacing and/or adding various hardware components, in addition to replacement of the removable sleds 105a-n, 115a-n that are installed in the chassis. In addition, once the chassis 100 has been deployed, firmware used by individual hardware components of the sleds 105a-n, 115a-n, or by other hardware components of chassis 100, may be modified in order to update the operations that are supported by these hardware components.

Chassis 100 may include one or more bays that each receive an individual sled (that may be additionally or alternatively referred to as a tray, blade, and/or node), such as compute sleds 105a-n and storage sleds 115a-n. Chassis 100 may support a variety of different numbers (e.g., 4, 8, 16, 32), sizes (e.g., single-width, double-width) and physical configurations of bays. Embodiments may include additional types of sleds that provide various storage, power and/or processing capabilities. For instance, sleds installable in chassis 100 may be dedicated to providing power management or networking functions. Sleds may be individually installed and removed from the chassis 100, thus allowing the computing and storage capabilities of a chassis to be reconfigured by swapping the sleds with diverse types of sleds, in some cases at runtime without disrupting the ongoing operations of the other sleds installed in the chassis 100.

Multiple chassis 100 may be housed within a rack. Data centers may utilize large numbers of racks, with various different types of chassis installed in various configurations of racks. The modular architecture provided by the sleds, chassis and racks allow for certain resources, such as cooling, power, and network bandwidth, to be shared by the compute sleds 105a-n and storage sleds 115a-n, thus providing efficiency improvements and supporting greater computational loads. For instance, certain computational tasks, such as computations used in machine learning and other artificial intelligence systems, may utilize computational and/or storage resources that are shared within an IHS, within an individual chassis 100 and/or within a set of IHSs that may be spread across multiple chassis of a data center.

Implementing computing systems that span multiple processing components of chassis 100 is aided by high-speed data links between these processing components, such as PCIe connections that form one or more distinct PCIe switch fabrics that are implemented by PCIe switches 135a-n, 165a-n installed in the sleds 105a-n, 115a-n of the chassis. These high-speed data links may be used to support algorithm implementations that span multiple processing, networking, and storage components of an IHS and/or chassis 100. For instance, computational tasks may be delegated to a specific processing component of an IHS, such as to a hardware accelerator 185a-n that may include one or more programmable processors that operate separate from the main CPUs 170a-n of computing sleds 105a-n. In various embodiments, such hardware accelerators 185a-n may include DPUs (Data Processing Units), GPUs (Graphics Processing Units), SmartNICs (Smart Network Interface Card) and/or FPGAs (Field Programmable Gate Arrays). These hardware accelerators 185a-n operate according to firmware instructions that may be occasionally updated, such as to adapt the capabilities of the respective hardware accelerators 185a-n to specific computing tasks.

Chassis 100 may be installed within a rack structure that provides at least a portion of the cooling utilized by the sleds 105a-n, 115a-n installed in chassis 100. In supporting airflow cooling, a rack may include one or more banks of cooling fans 130 that may be operated to ventilate heated air from within the chassis 100 that is housed within the rack. The chassis 100 may alternatively or additionally include one or more cooling fans 130 that may be similarly operated to ventilate heated air away from sleds 105a-n, 115a-n installed within the chassis. In this manner, a rack and a chassis 100 installed within the rack may utilize various configurations and combinations of cooling fans 130 to cool the sleds 105a-n, 115a-n and other components housed within chassis 100.

The sleds 105a-n, 115a-n may be individually coupled to chassis 100 via connectors that correspond to the bays provided by the chassis 100 and that physically and electrically couple an individual sled to a backplane 160. Chassis backplane 160 may be a printed circuit board that includes electrical traces and connectors that are configured to route signals between the various components of chassis 100 that are connected to the backplane 160 and between different components mounted on the printed circuit board of the backplane 160. In the illustrated embodiment, the connectors for use in coupling sleds 105a-n, 115a-n to backplane 160 include PCIe couplings that support high-speed data links with the sleds 105a-n, 115a-n. In various embodiments, backplane 160 may support diverse types of connections, such as cables, wires, midplanes, connectors, expansion slots, and multiplexers. In certain embodiments, backplane 160 may be a motherboard that includes various electronic components installed thereon. Such components installed on a motherboard backplane 160 may include components that implement all or part of the functions described with regard to the SAS (Serial Attached SCSI) expander 150, I/O controllers 145, network controller 140, chassis management controller 125 and power supply unit 135.

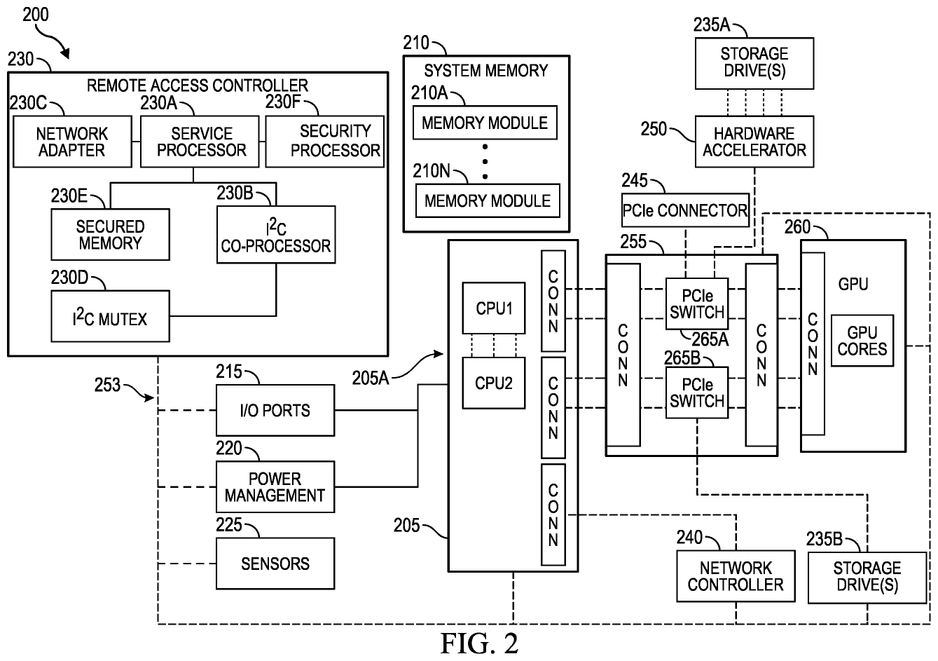

In certain embodiments, each individual sled 105a-n, 115a-n may be an IHS such as described with regard to IHS 200 of FIG. 2. Sleds 105a-n, 115a-n may individually or collectively provide computational processing resources that may be used to support a variety of e-commerce, multimedia, business, and scientific computing applications, such as artificial intelligence systems provided via cloud computing implementations. Sleds 105a-n, 115a-n are typically configured with hardware and software that provide leading-edge computational capabilities. Accordingly, services that are provided using such computing capabilities are typically provided as high-availability systems that operate with minimum downtime.

In high-availability computing systems, such as may be implemented using embodiments of chassis 100, any downtime that can be avoided is preferred. As described above, firmware updates are expected in the administration and operation of data centers, but it is preferable to avoid any downtime in making such firmware updates. For instance, in updating the firmware of the individual hardware components of the chassis 100, it is preferable that such updates can be made without having to reboot the chassis. As described in additional detail below, it is also preferable that updates to the firmware of individual hardware components of sleds 105a-n, 115a-n be likewise made without having to reboot the respective sled of the hardware component that is being updated.

As illustrated, each sled 105a-n, 115a-n includes a respective remote access controller (RAC) 110a-n, 120a-n also referred to as a Baseboard Management Controller (BMC). As described in additional detail with regard to FIG. 2, remote access controller 110a-n, 120a-n provides capabilities for remote monitoring and management of a respective sled 105a-n, 115a-n and/or of chassis 100. In support of these monitoring and management functions, remote access controllers 110a-n may utilize both in-band and sideband (i.e., out-of-band) communications with various managed components of a respective sled 105a-n and chassis 100. Remote access controllers 110a-n, 120a-n may collect diverse types of sensor data, such as collecting temperature sensor readings that are used in support of airflow cooling of the chassis 100 and the sled 105a-n, 115a-n. In addition, each remote access controller 110a-n, 120a-n may implement various monitoring and administrative functions related to a respective sled 105a-n, 115a-n, where these functions may be implemented using sideband bus connections with various internal components of the chassis 100 and of the respective sleds 105a-n, 115a-n. As described in additional detail below, in various embodiments, these capabilities of the remote access controllers 110a-n, 120a-n may be utilized in updating the firmware of hardware components of chassis 100 and/or of hardware components of the sleds 105a-n, 115a-n, without having to reboot the chassis or any of the sleds 105a-n, 115a-n.

The remote access controllers 110a-n, 120a-n that are present in chassis 100 may support secure connections with a remote management interface 101. In some embodiments, remote management interface 101 provides a remote administrator with various capabilities for remotely administering the operation of an IHS, including initiating updates to the firmware used by hardware components installed in the chassis 100. For example, remote management interface 101 may provide capabilities by which an administrator can initiate updates to all of the storage drives 175a-n installed in a chassis 100, or to all of the storage drives 175a-n of a particular model or manufacturer. In some instances, remote management interface 101 may include an inventory of the hardware, software, and firmware of chassis 100 that is being remotely managed through the operation of the remote access controllers 110a-n, 120a-n. The remote management interface 101 may also include various monitoring interfaces for evaluating telemetry data collected by the remote access controllers 110a-n, 120a-n. In some embodiments, remote management interface 101 may communicate with remote access controllers 110a-n, 120a-n via a protocol such the Redfish remote management interface.

In the illustrated embodiment, chassis 100 includes one or more compute sleds 105a-n that are coupled to the backplane 160 and installed within one or more bays or slots of chassis 100. Each of the individual compute sleds 105a-n may be an IHS, such as described with regard to FIG. 2. Each of the individual compute sleds 105a-n may include various different numbers and types of processors that may be adapted to performing specific computing tasks. In the illustrated embodiment, each of the compute sleds 105a-n includes a PCIe switch 135a-n that provides access to a hardware accelerator 185a-n, such as the described DPUs, GPUs, Smart NICs and FPGAs, which may be programmed and adapted for specific computing tasks, such as to support machine learning or other artificial intelligence systems. As described in additional detail below, compute sleds 105a-n may include a variety of hardware components, such as hardware accelerator 185a-n and PCIe switches 135a-n, that operate using firmware that may be occasionally updated.

As illustrated, chassis 100 includes one or more storage sleds 115a-n that are coupled to the backplane 160 and installed within one or more bays of chassis 100 in a similar manner to compute sleds 105a-n. Each of the individual storage sleds 115a-n may include various different numbers and types of storage devices. As described in additional detail with regard to FIG. 2, a storage sled 115a-n may be an IHS 200 that includes multiple solid-state drives (SSDs) 175a-n, where the individual storage drives 175a-n may be accessed through a PCIe switch 165a-n of the respective storage sled 115a-n.

As illustrated, a storage sled 115a may include one or more DPUs (Data Processing Units) 190 that provide access to and manage the operations of the storage drives 175a of the storage sled 115a. Use of a DPU 190 in this manner provides low-latency and high-bandwidth access to numerous SSDs 175a. These SSDs 175a may be utilized in parallel through NVMe transmissions that are supported by the PCIe switch 165a that connects the SSDs 175a to the DPU 190. In some instances, PCIe switch 165a may be an integrated component of a DPU 190. The immense data storage and retrieval capabilities provided by such storage sled 115a implementations may be harnessed by offloading storage operations directed as storage drives 175a to a DPU 190, and thus without relying on the main CPU of the storage sled, or of any other component of chassis 100. As indicated in FIG. 1, chassis 100 may also include one or more storage sleds 115n that provide access to storage drives 175n via a storage controller 195. In some embodiments, storage controller 195 may provide support for RAID (Redundant Array of Independent Disks) configurations of logical and physical storage drives, such as storage drives provided by storage sled 115n. In some embodiments, storage controller 195 may be a HBA (Host Bus Adapter) that provides more limited capabilities in accessing storage drives 175n.

In addition to the data storage capabilities provided by storage sleds 115a-n, chassis 100 may provide access to other storage resources that may be installed components of chassis 100 and/or may be installed elsewhere within a rack that houses the chassis 100. In certain scenarios, such storage resources (e.g., JBOD 155) may be accessed via a SAS expander 150 that is coupled to the backplane 160 of the chassis 100. The SAS expander 150 may support connections to a number of JBOD (Just a Bunch of Disks) storage resources 155 that, in some instances, may be configured and managed individually and without implementing data redundancy across the various drives. The additional JBOD storage resources 155 may also be at various other locations within a datacenter in which chassis 100 is installed.

In light of the various manners in which storage drives 175a-n, 155 may be coupled to chassis 100, a wide variety of different storage topologies may be supported. Through these supported topologies, storage drives 175a-n, 155 may be logically organized into clusters or other groupings that may be collectively tasked and managed. In some instances, a chassis 100 may include numerous storage drives 175a-n, 155 that are identical, or nearly identical, such as arrays of SSDs of the same manufacturer and model. Accordingly, any firmware updates to storage drives 175a-n, 155 require the updates to be applied within each of these topologies being supported by the chassis 100. Despite the large number of different storage drive topologies that may be supported by an individual chassis 100, the firmware used by each of these storage devices 175a-n, 155 may be occasionally updated. In some instances, firmware updates may be limited to a single storage drive, but in other instances, firmware updates may be initiated for a large number of storage drives, such as for all SSDs installed in chassis 100.

As illustrated, the chassis 100 of FIG. 1 includes a network controller 140 that provides network access to the sleds 105a-n, 115a-n installed within the chassis. Network controller 140 may include various switches, adapters, controllers, and couplings used to connect chassis 100 to a network, either directly or via additional networking components and connections provided via a rack in which chassis 100 is installed. Network controller 140 operates according to firmware instructions that may be occasionally updated.

Chassis 100 may similarly include a power supply unit 135 that provides the components of the chassis with various levels of DC power from an AC power source or from power delivered via a power system provided by a rack within which chassis 100 may be installed. In certain embodiments, power supply unit 135 may be implemented within a sled that may provide chassis 100 with redundant, hot-swappable power supply units. Power supply unit 135 may operate according to firmware instructions that may be occasionally updated.

Chassis 100 may also include various I/O controllers 145 that may support various I/O ports, such as USB ports that may be used to support keyboard and mouse inputs and/or video display capabilities. Each of the I/O controllers 145 may operate according to firmware instructions that may be occasionally updated. Such I/O controllers 145 may be utilized by the chassis management controller 125 to support various KVM (Keyboard, Video and Mouse) 125a capabilities that provide administrators with the ability to interface with the chassis 100. The chassis management controller 125 may also include a storage module 125c that provides capabilities for managing and configuring certain aspects of the storage devices of chassis 100, such as the storage devices provided within storage sleds 115a-n and within the JBOD 155.

In addition to providing support for KVM 125a capabilities for administering chassis 100, chassis management controller 125 may support various additional functions for sharing the infrastructure resources of chassis 100. In some scenarios, chassis management controller 125 may implement tools for managing the power supply unit 135, network controller 140 and airflow cooling fans 130 that are available via the chassis 100. As described, the airflow cooling fans 130 utilized by chassis 100 may include an airflow cooling system that is provided by a rack in which the chassis 100 may be installed and managed by a cooling module 125b of the chassis management controller 125.

FIG. 2 illustrates an example of an IHS 200 configured to implement systems and methods described herein according to one embodiment of the present disclosure. It should be appreciated that although the embodiments described herein may describe an IHS that is a compute sled or similar computing component that may be deployed within the bays of a chassis, a variety of other types of IHSs, such as laptops and portable devices, may also operate according to embodiments described herein. In the illustrative embodiment of FIG. 2, IHS 200 may be a computing component, such as sled 105a-n, 115a-n or other type of server, such as a 1RU server installed within a 2RU chassis, which is configured to share infrastructure resources provided within a chassis 100.

IHS 200 may utilize one or more system processors 205, that may be referred to as CPUs (central processing units). In some embodiments, CPUs 205 may each include a plurality of processing cores that may be separately delegated with computing tasks. Each of the CPUs 205 may be individually designated as a main processor and as a co-processor, where such designations may be based on delegation of specific types of computational tasks to a CPU 205. In some embodiments, CPUs 205 may each include an integrated memory controller that may be implemented directly within the circuitry of each CPU 205. In some embodiments, a memory controller may be a separate integrated circuit that is located on the same die as the CPU 205. Each memory controller may be configured to manage the transfer of data to and from a system memory 210 of the IHS, in some cases using a high-speed memory bus 205a. The system memory 210 is coupled to CPUs 205 via one or more memory buses 205a that provide the CPUs 205 with high-speed memory used in the execution of computer program instructions by the CPUs 205. Accordingly, system memory 210 may include memory components, such as static RAM (SRAM), dynamic RAM (DRAM), NAND Flash memory, suitable for supporting high-speed memory operations by the CPUs 205. In certain embodiments, system memory 210 may combine persistent non-volatile memory and volatile memory.

In certain embodiments, the system memory 210 may be comprised of multiple removable memory modules. The system memory 210 of the illustrated embodiment includes removable memory modules 210a-n. Each of the removable memory modules 210a-n may correspond to a printed circuit board memory socket that receives a removable memory module 210a-n, such as a DIMM (Dual In-line Memory Module), that can be coupled to the socket and then decoupled from the socket as needed, such as to upgrade memory capabilities or to replace faulty memory modules. Other embodiments of IHS system memory 210 may be configured with memory socket interfaces that correspond to diverse types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each CPU 205. All or portions of the chipset may be implemented directly within the integrated circuitry of an individual CPU 205. The chipset may provide the CPU 205 with access to a variety of resources accessible via one or more in-band buses. IHS 200 may also include one or more I/O ports 215 that may be used to couple the IHS 200 directly to other IHSs, storage resources, diagnostic tools, and/or other peripheral components. A variety of additional components may be coupled to CPUs 205 via a variety of in-line buses. For instance, CPUs 205 may also be coupled to a power management unit 220 that may interface with a power system of the chassis 100 in which IHS 200 may be installed. In addition, CPUs 205 may collect information from one or more sensors 225 via a management bus.

In certain embodiments, IHS 200 may operate using a BIOS (Basic Input/Output System) that may be stored in a non-volatile memory accessible by the CPUs 205. The BIOS may provide an abstraction layer by which the operating system of the IHS 200 interfaces with hardware components of the IHS. Upon powering or restarting IHS 200, CPUs 205 may utilize BIOS instructions to initialize and test hardware components coupled to the IHS, including both components permanently installed as components of the motherboard of IHS 200, and removable components installed within various expansion slots supported by the IHS 200. The BIOS instructions may also load an operating system for execution by CPUs 205. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 230.

In some embodiments, IHS 200 may include a TPM (Trusted Platform Module) that may include various registers, such as platform configuration registers, and a secure storage, such as an NVRAM (Non-Volatile Random-Access Memory). The TPM may also include a cryptographic processor that supports various cryptographic capabilities. In IHS embodiments that include a TPM, a pre-boot process implemented by the TPM may utilize its cryptographic capabilities to calculate hash values that are based on software and/or firmware instructions utilized by certain core components of IHS, such as the BIOS and boot loader of IHS 200. These calculated hash values may then be compared against reference hash values that were previously stored in a secure non-volatile memory of the IHS, such as during factory provisioning of IHS 200. In this manner, a TPM may establish a root of trust that includes core components of IHS 200 that are validated as operating using instructions that originate from a trusted source.

As illustrated, CPUs 205 may be coupled to a network controller 240, such as provided by a Network Interface Controller (NIC) card that provides IHS 200 with communications via one or more external networks, such as the Internet, a LAN, or a WAN. In some embodiments, network controller 240 may be a replaceable expansion card or adapter that is coupled to a connector (e.g., PCIe connector of a motherboard, backplane, midplane, etc.) of IHS 200. In some embodiments, network controller 240 may support high-bandwidth network operations by the IHS 200 through a PCIe interface that is supported by the chipset of CPUs 205. Network controller 240 may operate according to firmware instructions that may be occasionally updated.

As indicated in FIG. 2, in some embodiments, CPUs 205 may be coupled to a PCIe card 255 that includes two PCIe switches 265a-b that operate as I/O controllers for PCIe communications, such as TLPs (Transaction Layer Packets), that are transmitted between the CPUs 205 and PCIe devices and systems coupled to IHS 200. Whereas the illustrated embodiment of FIG. 2 includes two CPUs 205 and two PCIe switches 265a-b, different embodiments may operate using different numbers of CPUs and PCIe switches. In addition to serving as I/O controllers that route PCIe traffic, PCIe switches 265a-b include switching logic that can be used to expand the number of PCIe connections that are supported by CPUs 205. PCIe switches 265a-b may multiply the number of PCIe lanes available to CPUs 205, thus allowing more PCIe devices to be connected to CPUs 205, and for the available PCIe bandwidth to be allocated with greater granularity. Each of the PCIe switches 265a-b may operate according to firmware instructions that may be occasionally updated.

Using the available PCIe lanes, the PCIe switches 265a-b may be used to implement a PCIe switch fabric. Also through this switch fabric, PCIe NVMe (Non-Volatile Memory Express) transmission may be supported and utilized in high-speed communications with SSDs, such as storage drives 235a-b, of the IHS 200. Also through this switch fabric, PCIe VDM (Vendor Defined Messaging) may be supported and utilized in managing PCIe-compliant hardware components of the IHS 200, such as in updating the firmware utilized by the hardware components.

As indicated in FIG. 2, IHS 200 may support storage drives 235a-b in various topologies, in the same manner as described with regard to the chassis 100 of FIG. 1. In the illustrated embodiment, storage drives 235a are accessed via a hardware accelerator 250, while storage drives 235b are accessed directly via PCIe switch 265b. In some embodiments, the storage drives 235a-b of IHS 200 may include a combination of both SSD and magnetic disk storage drives. In other embodiments, all of the storage drives 235a-b of IHS 200 may be identical, or nearly identical. In all embodiments, storage drives 235a-b operate according to firmware instructions that may be occasionally updated.

As illustrated, PCIe switch 265a is coupled via a PCIe link to a hardware accelerator 250, such as a DPU, SmartNIC, GPU and/or FPGA, that may be a connected to the IHS via a removable card or baseboard that couples to a PCIe connector of the IHS 200. In some embodiments, hardware accelerator 250 includes a programmable processor that can be configured for offloading functions from CPUs 205. In some embodiments, hardware accelerator 250 may include a plurality of programmable processing cores and/or hardware accelerators, which may be used to implement functions used to support devices coupled to the IHS 200. In some embodiments, the processing cores of hardware accelerator 250 include ARM (advanced RISC (reduced instruction set computing) machine) processing cores. In other embodiments, the cores of the DPUs may include MIPS (microprocessor without interlocked pipeline stages) cores, RISC-V cores, or CISC (complex instruction set computing) (i.e., x86) cores. Hardware accelerator may operate according to firmware instructions that may be occasionally updated.

In the illustrated embodiment, the programmable capabilities of hardware accelerator 250 implement functions used to support storage drives 235a, such as SSDs. In such storage drive topologies, hardware accelerator 250 may implement processing of PCIe NVMe communications with SSDs 235a, thus supporting high-bandwidth connections with these SSDs. Hardware accelerator 250 may also include one or more memory devices used to store program instructions executed by the processing cores and/or used to support the operation of SSDs 235a such as in implementing cache memories and buffers utilized in support of high-speed operation of these storage drives, and in some cases may be used to provide high-availability and high-throughput implementations of the read, write and other I/O operations that are supported by these storage drives 235a. In other embodiments, hardware accelerator 250 may implement operations in support of other types of devices and may similarly support high-bandwidth PCIe connections with these devices. For instance, in various embodiments, hardware accelerator 250 may support high-bandwidth connections, such as PCIe connections, with networking devices in implementing functions of a network switch, compression and codec functions, virtualization operations or cryptographic functions.

As illustrated in FIG. 2, PCIe switches 265a-b may also support PCIe couplings with one or more GPUs (Graphics Processing Units) 260. Embodiments may include one or more GPU cards, where each GPU card is coupled to one or more of the PCIe switches 265a-b, and where each GPU card may include one or more GPUs 260. In some embodiments, PCIe switches 265a-b may transfer instructions and data for generating video images by the GPUs 260 to and from CPUs 205. Accordingly, GPUs 260 may include one or more hardware-accelerated processing cores that are optimized for performing streaming calculation of vector data, matrix data and/or other graphics data, thus supporting the rendering of graphics for display on devices coupled either directly or indirectly to IHS 200. In some instances, GPUs may be utilized as programmable computing resources for offloading other functions from CPUs 205, in the same manner as hardware accelerator 250. GPUs 260 may operate according to firmware instructions that may be occasionally updated.

As illustrated in FIG. 2, PCIe switches 265a-b may support PCIe connections in addition to those utilized by GPUs 260 and hardware accelerator 250, where these connections may include PCIe links of one or more lanes. For instance, PCIe connectors 245 supported by a printed circuit board of IHS 200 may allow various other systems and devices to be coupled to IHS 200. Through couplings to PCIe connectors 245, a variety of data storage devices, graphics processors and network interface cards may be coupled to IHS 200, thus supporting a wide variety of topologies of devices that may be coupled to the IHS 200.

As described, IHS 200 includes a remote access controller (RAC) 230 that supports remote management of IHS 200 and of various internal components of IHS 200. In certain embodiments, remote access controller 230 may operate from a different power plane from the CPUs 205 and other components of IHS 200, thus allowing the remote access controller 230 to operate, and manage tasks to proceed, while the processing cores of IHS 200 are powered off. Various functions provided by the BIOS, including launching the operating system of the IHS 200, and/or functions of a TPM may be implemented or supplemented by the remote access controller 230. In some embodiments, the remote access controller 230 may perform various functions to verify the integrity of the IHS 200 and its hardware components prior to initialization of the operating system of IHS 200 (i.e., in a bare-metal state). In some embodiments, certain operations of the remote access controller 230, such as the operations described herein for updating firmware used by managed hardware components of IHS 200, may operate using validated instructions, and thus within the root of trust of IHS 200.

In some embodiments, remote access controller 230 may include a service processor 230a, or specialized microcontroller, which operates management software that supports remote monitoring and administration of IHS 200. The management operations supported by remote access controller 230 may be remotely initiated, updated, and monitored via a remote management interface 101, such as described with regard to FIG. 1. Remote access controller 230 may be installed on the motherboard of IHS 200 or may be coupled to IHS 200 via an expansion slot or other connector provided by the motherboard. In some instances, the management functions of the remote access controller 230 may utilize information collected by various managed sensors 225 located within the IHS. For instance, temperature data collected by sensors 225 may be utilized by the remote access controller 230 in support of closed-loop airflow cooling of the IHS 200. As indicated, remote access controller 230 may include a secured memory 230e for exclusive use by the remote access controller in support of management operations.

In some embodiments, the remote access controller 230 may include a security processor 230F (e.g., hardware Root-of-Trust (RoT)). Logically, the Security Processor 230f and the Remote Access Controller 230 may be separate entities. In some cases, the Security Processor 230f and the Remote Access Controller 230 may exist inside of a single System-on-Chip (SoC), while others have it in two separate SP SoC and BMC SoC.

In some embodiments, remote access controller 230 may implement monitoring and management operations using MCTP (Management Component Transport Protocol) messages that may be communicated to managed devices 205, 235a-b, 240, 250, 255, 260 via management connections supported by a sideband bus 253. In some embodiments, the remote access controller 230 may additionally or alternatively use MCTP messaging to transmit Vendor Defined Messages (VDMs) via the in-line PCIe switch fabric supported by PCIe switches 265a-b. In some instances, the sideband management connections supported by remote access controller 230 may include PLDM (Platform Level Data Model) management communications with the managed devices 205, 235a-b, 240, 250, 255, 260 of IHS 200.

As illustrated, remote access controller 230 may include a network adapter 230c that provides the remote access controller with network access that is separate from the network controller 240 utilized by other hardware components of the IHS 200. Through secure connections supported by network adapter 230c, remote access controller 230 communicates management information with remote management interface 101. In support of remote monitoring functions, network adapter 230c may support connections between remote access controller 230 and external management tools using wired and/or wireless network connections that operate using a variety of network technologies. As a non-limiting example of a remote access controller, the integrated Dell Remote Access Controller (iDRAC) from Dell® is embedded within Dell servers and provides functionality that helps information technology (IT) administrators deploy, update, monitor, and maintain servers remotely.

Remote access controller 230 supports monitoring and administration of the managed devices of an IHS via a sideband bus 253. For instance, messages utilized in device and/or system management may be transmitted using I2C sideband bus 253 connections that may be individually established with each of the respective managed devices 205, 235a-b, 240, 250, 255, 260 of the IHS 200 through the operation of an I2C multiplexer 230d of the remote access controller. As illustrated in FIG. 2, the managed devices 205, 235a-b, 240, 250, 255, 260 of IHS 200 are coupled to the CPUs 205, either directly or indirectly, via in-line buses that are separate from the I2C sideband bus 253 connections used by the remote access controller 230 for device management.

In certain embodiments, the service processor 230a of remote access controller 230 may rely on an I2C co-processor 230b to implement sideband I2C communications between the remote access controller 230 and the managed hardware components 205, 235a-b, 240, 250, 255, 260 of the IHS 200. The I2C co-processor 230b may be a specialized co-processor or micro-controller that is configured to implement a I2C bus interface used to support communications with managed hardware components 205, 235a-b, 240, 250, 255, 260 of IHS. In some embodiments, the I2C co-processor 230b may be an integrated circuit on the same die as the service processor 230a, such as a peripheral system-on-chip feature that may be provided by the service processor 230a. The I2C sideband bus 253 is illustrated as single line in FIG. 2. However, sideband bus 253 may be comprised of multiple signaling pathways, where each may be comprised of a clock line and data line that couple the remote access controller 230 to I2C endpoints 205, 235a-b, 240, 250, 255, 260.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 205 as a systems-on-a-chip.

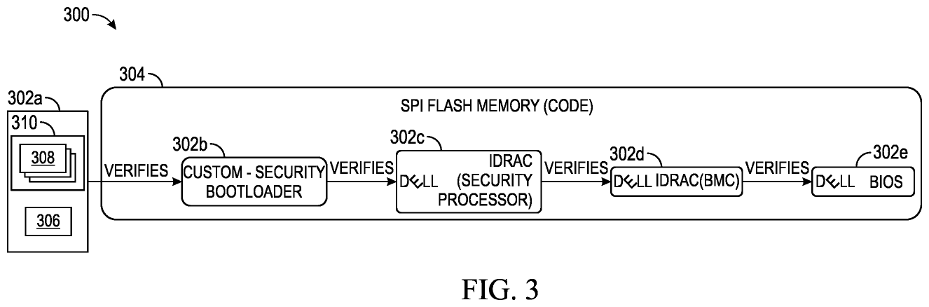

FIG. 3 illustrates an example boot process 300 that may be performed by the multi-party authorized secure boot system according to one embodiment of the present disclosure. The boot process 300 as shown may be adapted for use with a SoC-type architecture, such as a BMC 230 as described herein above. Nevertheless, it should be appreciated that the multi-party authorized secure boot system may be implemented on any suitable type of boot process that authorizes one or more portions of its boot code to provide a secure boot environment.

The boot process 300 generally includes multiple phases (collectively 302) including a fused authentication phase 302a, a security bootloader phase 302b, a BMC security processor phase 302c, a BMC bootloader phase 302d, and a BIOS bootloader phase 302e. For example, the security bootloader phase 302b, BMC security processor phase 302c, BMC bootloader phase 302d, and BIOS bootloader phase 302e may configured in a Serial Peripheral Interface (SPI) flash memory code 304, while the fused authentication phase 302a may be built into the SoC chip when it is manufactured by the SoC vendor.

According to embodiments of the present disclosure, the multi-party authorized secure boot system includes a multi-party authentication process 306 that is used by the fused authentication phase 302a to programmatically identify from among multiple certificates 308, a certain combination of certificates that may be used to authorize an ensuing phase 302 of the boot process 300. The certificates 308 may be stored in a secure memory 310 of any suitable system, such as that used by a processor (e.g., SoC) that performs the fused authentication phase 302a. Although the multi-party authorized secure boot process 304 is shown herein as being performed by the fused multi-party authorized secure boot process 302a, it should be appreciated that in other embodiments, the multi-party authorized secure boot process 304 may be performed at any suitable phase 302 of the boot process without departing from the spirit and scope of the present disclosure. For example, the multi-party authorized secure boot process 306 may be performed by either of the security bootloader phase 302b, BMC security processor phase 302c, and BMC bootloader phase 302d, for their respective ensuing stages, which in this particular example, would be the BMC security processor phase 302c, BMC bootloader phase 302d, and BIOS bootloader phase 302e, respectively.

Use of the multi-party authorized secure boot process 306 in the fused authentication phase 302a may be particularly beneficial in that the multi-party authorized secure boot process 306 and certificate keys 308 may be stored in a Mask ROM (MROM) portion a chip (e.g., SoC) that authorizes the authentication phase 302b. The MROM essentially forms an immutable portion of firmware because it is loaded at first power on and is masked when ensuing phases 302 are loaded and executed. For example, the multi-party authorized secure boot process 306 and certificate keys 308 may be stored (e.g., burned) into the chip during its manufacture.

Code ownership can be contentious and complicated, as the first mutable code, which in the present case, is the authentication phase 302b, provides the foundational trust of all subsequent code executed by an IHS 100. For example, compliance with cryptographic algorithms regulations may require the immutable MROM configured in the authentication phase 302a. This is difficult as the MROM cannot be changed in silicon without re-vamping the SoC's manufacturing process (e.g., a re-spin), and even then, the re-vamped manufacturing process would only apply to new products with the new chip.

While the multi-party authorized secure boot system has been described herein as being related to an overall IHS 100, in other embodiments, it is contemplated that the multi-party authorized secure boot system may be implemented with any type and structure of sub-components configured in the IHS 100. Certain sub-components such as DPUs, Switches, Network Controllers, PSUs, GPUs, SmartNICs, and the like may be configured with security processors for whom the multi-party authorized secure boot system may be applicable. For example, the MPAT 400 may be configured with certificate keys 308 that allows a vendor of a PSU to access those portions of the IHS 100 related to how electrical power is generated and/or used by other sub-components in the IHS 100. Furthering this example, the MPAT 400 may be configured with certificate keys 308 that allow the PSU vendor to access the PSU 135 as well as the power data for other sub-components stored in the BIOS portion of the IHS 100.

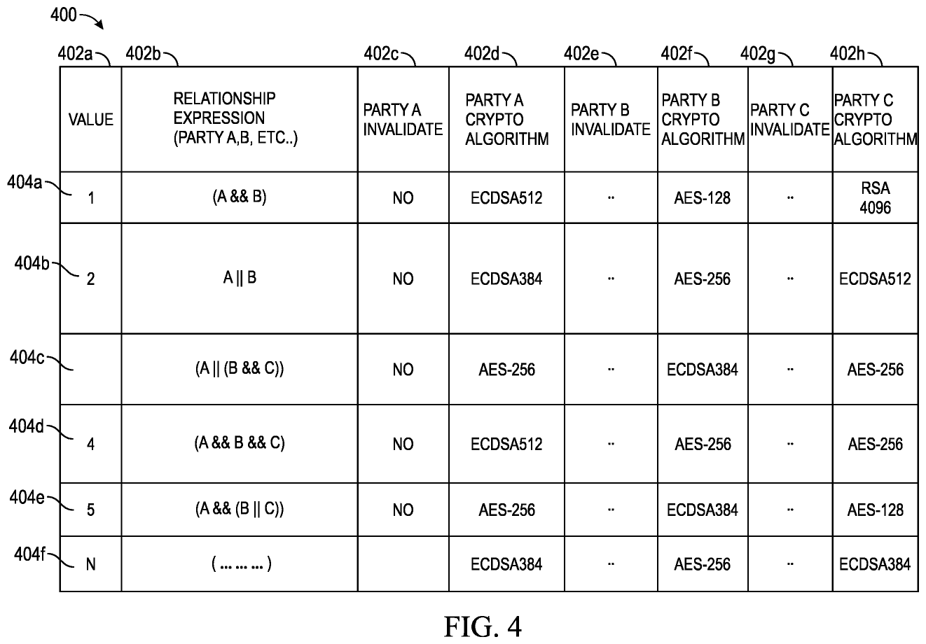

FIG. 4 illustrates an example multi-party authorization table (MPAT) 400 that may be used to select which combination of certificates 308 are used to authorize the next ensuing phase 302 of a boot process 300 according to one embodiment of the present disclosure. The MPAT 400 may be stored in the same memory location that the multi-party authorized secure boot process 306 is stored. For example, the MPAT 400 may be stored in the MROM portion of memory used by the fused authentication phase 302a.

The MPAT 400 includes a number of columns 402 that identify various criteria associated with a number of relationship combinations each arranged in one of multiple rows 404a-e. Column 402a indicates a numeric value assigned to each relationship combination as indicated in column 402b. Columns 402c,d indicates certain criteria to be associated with a certificate key ‘A’ as specified in column 402b. For example, column 402c indicates whether the certificate key ‘A’ is invalidated or not, while column 402d indicates a particular cryptographical algorithm (e.g., SHA-256, SHA-512/224, RSA, ECDSA512, etc.) that is to be used with certificate key ‘A’. Columns 402e,f are similar to columns 402c,d, except that they are associated with the certificate key ‘B’ as identified in column 402b. Additionally, columns 402g,h are similar to columns 402c,d, except that they are associated with the certificate key ‘C’ as identified in column 402b. Additional columns may be added for additional certificate keys as specified in column 402b. The invalidated criterion generally refers to a certificate key that has been removed from use. For example, a certificate key belonging to a certain owner may be invalidated when that owner sells the IHS 100 to another different user.

Each certificate key (e.g., ‘A’, ‘B’, and ‘C’) represents a certificate key held by an owner or manager (e.g., party) of that cert. The certificate keys may be owned and managed by processes of different vendors or manufacturers. For example, one certificate key (e.g., certificate key ‘A’) may be owned and managed by a first corporation, while another certificate key (e.g., certificate key ‘C’) is owned and managed by another corporation having a limited interest in the administration of an IHS 100 that uses the multi-party authorized secure boot process 306. For example, a IHS vendor may provide maintenance (e.g., ongoing software updates) may own one cert, while the user (e.g., customer) of the IHS may own another cert. Each relationship combination may indicate any suitable quantity and type of certificate keys. For example, one relationship combination may indicate only one cert, such as a standard certificate key used by an administrator of the IHS 100. One example of such a standard certificate key may be a DELL POWEREDGE™ secure boot certificate key owned and managed by the Dell Corporation.

Another example scenario may include migration of certificate key structure that may be adopted by a corporation over time. For example, a corporation decides that a year from now, a new higher key strength algorithm is to be adopted across its IHS product line, yet immediate cut over to the new higher key strength algorithm may not be feasible. Thus, the corporation may implement a relationship combination number ‘2’ in which both the current and new certificate keys may be used, and when total cut-over to the new higher key strength algorithm has been achieved, the old certificate key may be invalidated as shown in column 402c of the MPAT 400 of FIG. 4.

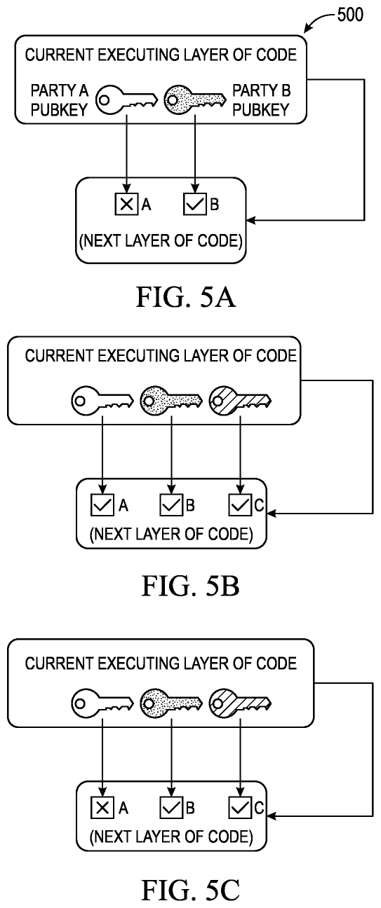

According to one embodiment, the relationship combinations may be specified according to Boolean operators to denote how multiple certificate keys may be related to each other, and as such, how the certificate keys are to be applied. For example, FIG. 5A illustrates how the certificate keys ‘A’ and ‘B’ may be applied when relationship combination number ‘2’ of the MPAT 400 is selected. As shown, either of certificate key ‘A’ or ‘B’ may be used to successfully authorize the ensuing phase 302. Such a scenario may exist when, for example, multiple firmware versions of the BMC 230 from different parties may be loaded onto, and executed on the BMC 230. An example of such a scenario may include the DELL POWEREDGE™ secure boot certificate key owned and managed by the Dell Corporation to load an execute its vendor-supplied firmware onto the BMC 230, and a DELL POWEREDGE C™ HyperScale secure boot certificate key owned and managed by a developer of a custom firmware version (e.g., openBMC) of the BMC 230.

As another example, FIG. 5B illustrates how the certificate keys ‘A’, ‘B’, and ‘C’ may be applied when relationship combination number ‘4’ of the MPAT 400 is selected. As shown, all certificate keys ‘A’, ‘B’, and ‘C’ must be used to successfully authorize the ensuing phase 302. Scenarios exist where it would be beneficial to require the certificate key of multiple parties. For example, one such scenario may exist when a vendor of the IHS 100 (e.g., a first party) develops code and supports a user of the IHS 100 (e.g., a second party), yet the user has final authorization/revocation control. Thus, both should be required to sign the secure boot portion of the ensuing phase 302.

For yet another example, FIG. 5C illustrates how the certificate keys ‘A’, ‘B’, and ‘C’ may be applied when relationship combination number ‘3’ of the MPAT 400 is selected. As shown, even though certificate key ‘A’ is not authorized, only certificate keys ‘B’ and ‘C’ must be used to successfully authorize the ensuing phase 302 or alternatively, only certificate key ‘A’ may be used to successfully authorize the ensuing phase 302. Such a scenario may exist when, for example, a vendor-supplied firmware of a vendor (e.g., party ‘A’) may authorize the ensuing phase 302, or a vendor of the IHS 100 (e.g., party ‘B’) develops code and supports a user of the IHS 100 (e.g., party ‘C’), yet the user has final authorization/revocation control. Thus in this case, either certificate key ‘A’ of party ‘A’ may sign the firmware of the ensuing phase 302, or in the alternative, both certificate keys ‘B’ and ‘C’ of parties ‘B’ and ‘C’ may sign the firmware of the ensuing phase 302.

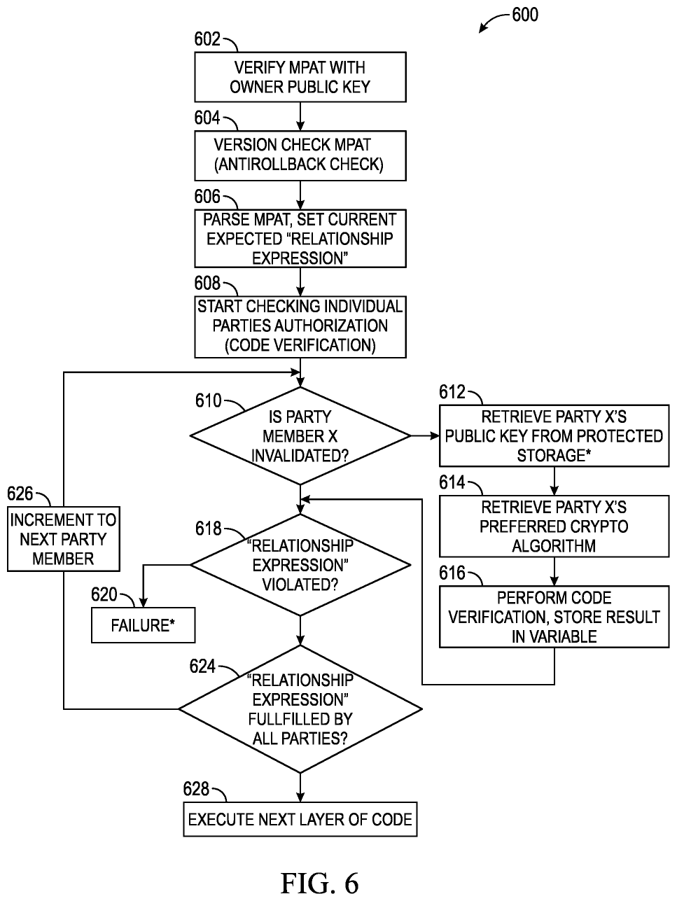

FIG. 6 illustrates an example multi-party secure boot authentication method 600 that may be used to provide authentication of the firmware of an ensuing phase of a boot process according to one embodiment of the present disclosure. The multi-party authorized secure boot method 600 may be performed at least in part, by a BMC 230, such as described above with reference to FIG. 3. In other embodiments, the multi-party authorized secure boot method 600 may be performed by any suitable process that performs attestation of firmware for an ensuing phase of a boot process.

Initially at step 602, the method 600 verifies the MPAT 400 with the owner public key. That is, the method 600 performs an attestation on the MPAT 400 to ensure that it has not been tampered with. Thereafter at step 604, the method 600 checks the version of the MPAT 400, such as by ensuring the MPAT 400 has not been inadvertently or illicitly been reverted to an earlier version. For example, the method 600 may check the MPAT 400 to ensure that its version lies within a certain range of allowable versions. The method 600 then parses the MPAT 400 and sets the current expected relationship combination expression at step 606. For example, the method 600 may select either one of the relationship combinations (e.g., values 1-6) as indicated in column 402a, and associate the criteria indicated for each certificate key as indicated in columns 402c-h of the MPAT 400.

At step 608, the method 600 begins checking individual parties authorization. For example, the method 600 may obtain a hash of the firmware of the ensuing code segment using the cryptographic algorithm specified, such as in columns 302d, 302f, and 302h, and compare with its stored version to determine whether a match occurs. Thereafter at step 610, the method 600 determines whether the current certificate key has been invalidated. If so, processing continues at step 618; otherwise, process continues at step 612 in which the method 600 retrieves the current certificate key 308 from protected storage, retrieves the cryptographical algorithm type, such as from columns 302d, 302f, and 302h of the MPAT 400 at step 614, and perform code verification (e.g., compare with its stored version to determine whether a match occurs) at step 616.

At step 618, the method 600 determines whether the relationship combination as identified in column 402b of the MPAT 400 can no longer succeed. For example, if the code verification performed at step 616 has failed, and no other yet to be verified certificate keys exist that can potentially result in an overall successful verification, then the relationship combination can no longer succeed. If the relationship combination can no longer succeed, processing continues at step 620 in which the process ends and the ensuing phase 302 is inhibited from being executed. In some embodiments, the method 600 may generate an alert message indicating the failure, such as one that may be sent to an administrator console via the Internet. However, if the relationship combination can still potentially succeed, processing continues at step 624 in which the method 600 determines whether the relationship combination has been fulfilled by the certificate keys 308 of all necessary parties. If so, processing continues at step 628 in which the ensuing phase 302 is executed to continue the boot process 300. Otherwise process continues at step 626 in which the method 600 selects the next certificate key in the relationship combination for performing the code verification test as specified in steps 610-624. That is, the method may successively test each certificate key in the relationship combination until no combination of successful code verification tests exist (e.g., via step 618), or all necessary code verification tests allow successful execution of the next phase 302 (e.g., via step 624).

The multi-party authorized secure boot method 600 described above may be performed each time the boot process 300 is performed, such as every time the BMC 230 is re-booted and/or the IHS 100 that the BMC 230 is configured in is re-booted. Nevertheless, when use of the multi-party authorized secure boot method 600 is no longer needed or desired, the multi-party authorized secure boot method 600 ends.

While FIG. 6 illustrates an example multi-party authorized secure boot method 600 that may be implemented to provide secure authentication of boot firmware via multiple certificate keys 308, the features of the disclosed processes may be embodied in other specific forms without deviating from the spirit and scope of the present disclosure. For example, certain steps of the disclosed method 600 may be performed sequentially, or alternatively, they may be performed concurrently. As another example, the method 600 may perform additional, fewer, or different operations than those operations as described in the present example.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and Including) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A multi-party authorized secure boot system comprising:
a processing device comprising one or more processors and one or more memory units including instructions that, upon execution by the processors, cause the processing device to:
during a boot process of the processing device, identify two or more secure boot keys that may be used to authorize, using an authentication process, an ensuing phase of the boot process;
identify a subset of the secure boot keys that are to be used to perform the authentication process; and
using each of the subset of secure boot keys, perform the authentication process.

2. The multi-party authorized secure boot system of claim 1, wherein the processing device comprises a Baseboard Management Controller (BMC) configured in an Information Handling System (IHS).

3. The multi-party authorized secure boot system of claim 2, wherein the instructions are performed during a fused authentication phase of the boot process.

4. The multi-party authorized secure boot system of claim 1, wherein the secure boot keys are owned and managed by different parties.

5. The multi-party authorized secure boot system of claim 1, wherein the instructions, upon execution, cause the processing device to identify the subset of the secure boot keys that are to be used to perform the authentication process using one or more Boolean operators.

6. The multi-party authorized secure boot system of claim 5, wherein the instructions, upon execution, cause the processing device to access a table that indicates the certificate keys and a relationship of the certificate keys using the Boolean operators.

7. The multi-party authorized secure boot system of claim 6, wherein the instructions, upon execution, cause the processing device to:
access the table to determine whether either one of the certificate keys has been invalidated; and
access the table to determine an appropriate cryptographic algorithm for each cert.

8. The multi-party authorized secure boot system of claim 1, wherein the instructions, upon execution, cause the processing device to when the ensuing phase does not pass the authentication process, inhibit booting of the ensuing phase.

9. A multi-party authorized secure boot method comprising:
during a boot process of a processing device, identifying two or more secure boot keys that may be used to authorize, using an authentication process, an ensuing phase of the boot process;
identifying a subset of the secure boot keys that are to be used to perform the authentication process; and
using each of the subset of secure boot keys, performing the authentication process.

10. The multi-party authorized secure boot method of claim 9, wherein the processing device comprises a Baseboard Management Controller (BMC) configured in an Information Handling System (IHS).

11. The multi-party authorized secure boot method of claim 10, further comprising performing the acts of identifying two or more secure boot keys, identifying a subset of the secure boot keys, and performing the authentication process by a fused authentication phase of the boot process.

12. The multi-party authorized secure boot method of claim 9, further comprising identifying the subset of the secure boot keys that are to be used to perform the authentication process using one or more Boolean operators.

13. The multi-party authorized secure boot method of claim 12, further comprising accessing a table that indicates the certificate keys and a relationship of the certificate keys using the Boolean operators.

14. The multi-party authorized secure boot method of claim 13, further comprising:
accessing the table to determine whether either one of the certificate keys has been invalidated; and
accessing the table to determine an appropriate cryptographic algorithm for each cert.

15. The multi-party authorized secure boot method of claim 9, further comprising inhibiting booting of the ensuing phase when the ensuing phase does not pass the authentication process.

16. A memory storage device having program instructions stored thereon that, upon execution by one or more processors of a processing device, cause the processing device to:
during a boot process of the processing device, identify two or more secure boot keys that may be used to authorize, using an authentication process, an ensuing phase of the boot process;
identify a subset of the secure boot keys that are to be used to perform the authentication process; and
using each of the subset of secure boot keys, perform the authentication process.

17. The memory storage device of claim 16, wherein the processing device comprises a Baseboard Management Controller (BMC) configured in an Information Handling System (IHS), and wherein the instructions are performed during a fused authentication phase of the boot process.

18. The memory storage device of claim 16, wherein the secure boot keys are owned and managed by different parties.

19. The memory storage device of claim 16, wherein the instructions, upon execution, cause the processing device to:
identify the subset of the secure boot keys that are to be used to perform the authentication process using one or more Boolean operators stored in a table;
access the table to determine whether either one of the certificate keys has been invalidated; and
access the table to determine an appropriate cryptographic algorithm for each cert.

20. The memory storage device of claim 16, wherein the instructions, upon execution, cause the processing device to when the ensuing phase does not pass the authentication process, inhibit booting of the ensuing phase.
